(19) United States
(12) Patent Application Publication
(10) Pub. No.: US 2026/0122053 A1
(43) Pub. Date: Apr. 30, 2026

(54) TENANT-SPECIFIC USER MANAGEMENT WITHIN MULTI-TENANT APPLICATIONS

(71) Applicant: OKTA, INC., SAN FRANCISCO, CA (US)

(72) Inventor: Aaron Curtis Smalser, Lake Stevens, WA (US)

(21) Appl. No.: 18/933,960

(22) Filed: Oct. 31, 2024

(51) Int. Cl. H04L 9/40

(52) U.S. Cl. CPC H04L 63/083

(57) ABSTRACT

An application may establish a connection between a first identity provider (IdP) that is associated with an identity management system and an authentication system associated with the application. Further, the application may receive, from a developer associated with the application, an indication of a mapping between a first set of attributes associated with the first IdP and a second set of attributes associated with the authentication system. The application may then transmit the indication of the mapping to the authentication system. The authentication system may further receive, from a tenant associated with the first IdP, a request message that includes data in the first set of attributes. As such, the authentication system may map the set of data of the request message to the second set of attributes in accordance with the received mapping and store the set of data within a tenant-specific data store based on the mapping.

### FIELD OF TECHNOLOGY

The present disclosure relates generally to identity management, and more specifically to tenant-specific user management within multi-tenant applications.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

In some examples, the identity management system may communicate with applications to exchange user identity information. In some cases, the identity management system may communicate with a relatively large quantity of applications and applications may communicate with a relatively large quantity of tenants via identity management systems. As such, some identity management systems may automate the user identity information exchanges. However, as the quantity of tenants that an identity management system may serve for an application may be relatively large, implementing such automations on a per-tenant level may be relatively inefficient and result in a relatively high level of resource consumption.

### SUMMARY

A method for user management by an application is described. The method may include establishing a first connection between a first identity provider and an authentication system associated with the application, the first identity provider associated with one or more tenants, receiving, from a first developer associated with the application, an indication of a mapping between a first set of attributes associated with the first identity provider and a second set of attributes associated with the authentication system, and transmitting, to the authentication system, the indication of the mapping, where a data store of the authentication system stores data from one or more request messages in accordance with the mapping, the data store being associated with a first tenant of the one or more tenants.

An application for user management is described. The application may include one or more memories storing processor executable code, and one or more processors coupled with the one or more memories. The one or more processors may individually or collectively be operable to execute the code to cause the application to establish a first connection between a first identity provider and an authentication system associated with the application, the first identity provider associated with one or more tenants, receive, from a first developer associated with the application, an indication of a mapping between a first set of attributes associated with the first identity provider and a second set of attributes associated with the authentication system, and transmit, to the authentication system, the indication of the mapping, where a data store of the authentication system stores data from one or more request messages in accordance with the mapping, the data store being associated with a first tenant of the one or more tenants.

Another application for user management is described. The application may include means for establishing a first connection between a first identity provider and an authentication system associated with the application, the first identity provider associated with one or more tenants, means for receiving, from a first developer associated with the application, an indication of a mapping between a first set of attributes associated with the first identity provider and a second set of attributes associated with the authentication system, and means for transmitting, to the authentication system, the indication of the mapping, where a data store of the authentication system stores data from one or more request messages in accordance with the mapping, the data store being associated with a first tenant of the one or more tenants.

A non-transitory computer-readable medium storing code for user management is described. The code may include instructions executable by one or more processors to establish a first connection between a first identity provider and an authentication system associated with the application, the first identity provider associated with one or more tenants, receive, from a first developer associated with the application, an indication of a mapping between a first set of attributes associated with the first identity provider and a second set of attributes associated with the authentication system, and transmit, to the authentication system, the indication of the mapping, where a data store of the authentication system stores data from one or more request messages in accordance with the mapping, the data store being associated with a first tenant of the one or more tenants.

Some examples of the method, applications, and non-transitory computer-readable medium described herein may further include operations, features, means, or instructions for configuring the first connection between the first identity provider and the authentication system with a set of operations for a respective tenant of the one or more tenants, the one or more request messages in accordance with the set of operations.

In some examples of the method, applications, and non-transitory computer-readable medium described herein, the set of operations includes a data retrieval operation, a data storage operation, a data update operation, a data removal operation, or any combination thereof.

In some examples of the method, applications, and non-transitory computer-readable medium described herein, establishing the first connection may include operations, features, means, or instructions for establishing, at the authentication system, an endpoint for the one or more request messages from the first tenant, the endpoint associated with the first tenant.

In some examples of the method, applications, and non-transitory computer-readable medium described herein, establishing the endpoint may include operations, features, means, or instructions for configuring the endpoint to support one or more authentication tokens.

In some examples of the method, applications, and non-transitory computer-readable medium described herein, the endpoint connects the first tenant to the data store of the authentication system that may be associated with the first tenant.

In some examples of the method, applications, and non-transitory computer-readable medium described herein, attributes of the first set of attributes associated with the first identity provider may be application programming interface (API) schema attributes.

In some examples of the method, applications, and non-transitory computer-readable medium described herein, the one or more request messages may be user management request messages, the data from the one or more request messages includes user management data, and the data store associated with the first tenant may be associated with the user management data for one or more users associated with the first tenant.

In some examples of the method, applications, and non-transitory computer-readable medium described herein, the authentication system includes a set of multiple data stores for the one or more tenants that includes the data store associated with the first tenant, the first identity provider may be included within a set of multiple identity providers that may be associated with different sets of one or more tenants, and the first connection may be included within a set of multiple connections between respective identity providers and the authentication system.

A method for user management by an authentication system is described. The method may include receiving, for a first connection between a first identity provider and an application associated with the authentication system, an indication of a mapping between a first set of attributes associated with the first identity provider and a second set of attributes associated with the authentication system, the first identity provider associated with a one or more tenants, receiving, from a first tenant of the one or more tenants associated with the first identity provider, a request message including a set of data associated with the first set of attributes, mapping, in response to receiving the request message, the set of data of the request message to the second set of attributes associated with the authentication system in accordance with the indication of the mapping for the first connection, and storing the set of data from the request message in a data store associated with the authentication system based on mapping the set of data of the request message to the second set of attributes associated with the authentication system, the data store associated with the first tenant.

An authentication system for user management is described. The authentication system may include one or more memories storing processor executable code, and one or more processors coupled with the one or more memories. The one or more processors may individually or collectively be operable to execute the code to cause the authentication system to receive, for a first connection between a first identity provider and an application associated with the authentication system, an indication of a mapping between a first set of attributes associated with the first identity provider and a second set of attributes associated with the authentication system, the first identity provider associated with a one or more tenants, receive, from a first tenant of the one or more tenants associated with the first identity provider, a request message including a set of data associated with the first set of attributes, mapping, in response to receive the request message, the set of data of the request message to the second set of attributes associated with the authentication system in accordance with the indication of the mapping for the first connection, and store the set of data from the request message in a data store associated with the authentication system based on mapping the set of data of the request message to the second set of attributes associated with the authentication system, the data store associated with the first tenant.

Another authentication system for user management is described. The authentication system may include means for receiving, for a first connection between a first identity provider and an application associated with the authentication system, an indication of a mapping between a first set of attributes associated with the first identity provider and a second set of attributes associated with the authentication system, the first identity provider associated with a one or more tenants, means for receiving, from a first tenant of the one or more tenants associated with the first identity provider, a request message including a set of data associated with the first set of attributes, means for mapping, in response to receiving the request message, the set of data of the request message to the second set of attributes associated with the authentication system in accordance with the indication of the mapping for the first connection, and means for storing the set of data from the request message in a data store associated with the authentication system based on mapping the set of data of the request message to the second set of attributes associated with the authentication system, the data store associated with the first tenant.

A non-transitory computer-readable medium storing code for user management is described. The code may include instructions executable by one or more processors to receive, for a first connection between a first identity provider and an application associated with the authentication system, an indication of a mapping between a first set of attributes associated with the first identity provider and a second set of attributes associated with the authentication system, the first identity provider associated with a one or more tenants, receive, from a first tenant of the one or more tenants associated with the first identity provider, a request message including a set of data associated with the first set of attributes, mapping, in response to receive the request message, the set of data of the request message to the second set of attributes associated with the authentication system in accordance with the indication of the mapping for the first connection, and store the set of data from the request message in a data store associated with the authentication system based on mapping the set of data of the request message to the second set of attributes associated with the authentication system, the data store associated with the first tenant.

Some examples of the method, authentication systems, and non-transitory computer-readable medium described herein may further include operations, features, means, or instructions for receiving, from the first tenant, a second request message indicating a request to read a second set of data from the data store at the authentication system that may be associated with the first tenant, the second request message including an indication of the second set of data associated with the first set of attributes, mapping, in response to receiving the second request message, the second set of data of the request message to the second set of attributes associated with the authentication system in accordance with the indication of the mapping for the first connection, querying the data store associated with the first tenant for the second set of data that may be associated with the second set of attributes to obtain the second set of data from the data store, mapping, in response to obtaining the second set of data from the data store, the second set of data obtained from the data store to the first set of attributes associated with the first identity provider, and transmitting, to the first tenant, a response message including the second set of data requested via the second request message, the second set of data associated with the first set of attributes, where the response message may be transmitted based on obtaining the second set of data and mapping the second set of data to the first set of attributes.

In some examples of the method, authentication systems, and non-transitory computer-readable medium described herein, receiving the request message may include operations, features, means, or instructions for receiving the request message via an endpoint at the authentication system for one or more request messages from the first tenant, the endpoint associated with the first tenant.

In some examples of the method, authentication systems, and non-transitory computer-readable medium described herein, receiving the request message may include operations, features, means, or instructions for receiving, from the first tenant, an authentication token via the request message, where mapping the set of data of the request message to the second set of attributes associated with the authentication system may be based on authenticating the authentication token from the first tenant.

In some examples of the method, authentication systems, and non-transitory computer-readable medium described herein, receiving the indication of the mapping may include operations, features, means, or instructions for receiving, via the indication of the mapping, an indication of a mapping between a first set of user schema attributes of an application programming interface (API) message and a second set of user schema attributes of the data store associated with the authentication system, the first set of attributes including the first set of user schema attributes and the second set of attributes including the second set of attributes, where the request message may be an API message.

In some examples of the method, authentication systems, and non-transitory computer-readable medium described herein, mapping the set of data of the request message to the second set of attributes may include operations, features, means, or instructions for mapping a set of data associated with the first set of user schema attributes of the API message to the second set of user schema attributes of the authentication system.

In some examples of the method, authentication systems, and non-transitory computer-readable medium described herein, the request message indicates a request for the authentication system to execute one or more operations, the one or more operations including a data retrieval operation, a data storage operation, a data update operation, a data removal operation, or any combination thereof.

In some examples of the method, authentication systems, and non-transitory computer-readable medium described herein, the request message may be associated with user management between the first tenant and the authentication system.

### BRIEF DESCRIPTION OF THE DRAWINGS

FIGS. 1 and 2 illustrate an example of a computing system that supports tenant-specific user management within multi-tenant applications in accordance with aspects of the present disclosure.

FIG. 3 shows an example of a process flow that supports tenant-specific user management within multi-tenant applications in accordance with aspects of the present disclosure.

FIG. 4 shows a block diagram of an apparatus that supports tenant-specific user management within multi-tenant applications in accordance with aspects of the present disclosure.

FIG. 5 shows a block diagram of an authentication system connection module that supports tenant-specific user management within multi-tenant applications in accordance with aspects of the present disclosure.

FIG. 6 shows a diagram of a system including a device that supports tenant-specific user management within multi-tenant applications in accordance with aspects of the present disclosure.

FIG. 7 shows a block diagram of an apparatus that supports tenant-specific user management within multi-tenant applications in accordance with aspects of the present disclosure.

FIG. 8 shows a block diagram of an authentication service that supports tenant-specific user management within multi-tenant applications in accordance with aspects of the present disclosure.

FIG. 9 shows a diagram of a system including a device that supports tenant-specific user management within multi-tenant applications in accordance with aspects of the present disclosure.

FIGS. 10 and 11 show flowcharts illustrating methods that support tenant-specific user management within multi-tenant applications in accordance with aspects of the present disclosure.

### DETAILED DESCRIPTION

In some examples, organizations may utilize identity management systems that manage user data and provide authentication services across various platforms. In some cases, the identity management system may act as an identity provider (IdP) for the organization. An IdP may be an example of a service that authenticates user identities and provides identity information to applications, thus enabling users of an organization to access multiple applications or services. In some cases, the IdP of an organization may automate the exchange of identity information for users of an organization with an application by utilizing an identity management protocol or exchange system. For example, the IdP may use the identity management protocol or exchange system for user provisioning.

If an organization adds a user and the IdP receives identity information for the user, the IdP may automatically exchange the identity information with an application to create an account for the user. However, in some examples, the identity management protocol or exchange system utilized by the IdP of an organization and the application may be different. For example, the IdP may use a first protocol format for exchanging information with an application and the application may use a second protocol format for exchanging information with the IdP. Therefore, a lack of protocol standardization may result in an increase in the complexity of identity information exchanges between an IdP and an application. In some examples, applications may develop connections for tenants or organizations that utilize the application to map data sent from the tenant within a first protocol format to a second protocol format used by the application. However, because applications may be associated with relatively large quantities of tenants, establishing such connections per tenant may be relatively inefficient and may result in an increase in resource consumption at the application and an authentication system associated with the application.

In accordance with the techniques of the present disclosure, to provide organizations a secure approach for user provisioning, a developer of an application (e.g., a multi-tenant application) may implement an IdP specific endpoint and a mapping between a first set of attributes used in messages from an IdP to a second set of attributes used by the authentication system. For example, the developer of the application may establish a first connection between a first IdP and an authentication system that is associated with the application. Moreover, the first IdP may be associated with one or more tenants or organizations. Further, the application may receive an indication of a mapping between a first set of attributes associated with the first IdP and a second set of attributes associated with the authentication system.

The application may then transmit the mapping to the authentication system such that a data store of the authentication system (e.g., that is associated with a tenant or organization) can store data from one or more request messages in accordance with the mapping. Further, the authentication system may receive, from a first tenant or a first organization of one or more tenants or organizations associated with the first IdP, a request message (e.g., a user management request message) that includes a set of data that is associated with the first set of attributes. That is, the set of data of the request message may be within a format such that the data is within the first set of attributes associated with the first IdP. Thus, in accordance with the received mapping, the authentication system may map the set of data of the request message to the second set of attributes associated with the authentication system.

By mapping the set of data to the second set of attributes, the authentication system may be enabled to store the set of data within a data store that is associated with the first tenant. Therefore, an application may be provided with connections to IdPs that organizations may utilize for user management, and the techniques of the present disclosure may enable mapping data from IdP messages to a format used by the application, such that the application can store user management data within tenant-specific data stores.

Further, based on receiving a request message from a tenant and mapping the data from the first set of attributes associated with an IdP to the second set of attributes associated with the authentication system, the authentication system may query a tenant-specific data store in accordance with the request to obtain data in response to the query. Moreover, to respond to the request message, the authentication system may map the obtained data from the second set of attributes to the first set of attributes in accordance with the received mapping such that the first tenant can receive the obtained data. Additionally, or alternatively, the messages from tenants of an IdP to the authentication system may be user management messages. For example, the first IdP may transmit messages on behalf of a tenant to add user accounts to an application, remove user accounts, adjust or modify user accounts, retrieve information on user accounts, or any combination thereof.

Therefore, the techniques of the present disclosure may enable a multi-tenant application to communicate with IdPs that are associated with multiple tenants for user management. In some cases, as an IdP may be associated with multiple tenants, the developer may be capable of reducing the quantity of resources associated with implementing the attribute mapping. For example, the techniques of the present disclosure may enable an application to use the same connection for multiple tenants, thus resulting in a reduction in a quantity of connections and mappings that a developer has to implement for the application. In some other cases, the techniques of the present disclosure may enable a developer a capability of controlling the supported user provisioning behaviors of each respective IdP connection rather than building and implementing separate systems for each type of connection. Thus, updating and maintaining the attribute mappings may be relatively easier resulting in a relatively more efficient and secure system for user management between IdPs and a multi-tenant application.

Aspects of the disclosure are initially described in the context of a computing system. Additional aspects of the disclosure are described with reference to a computing system and a process flow. Aspects of the disclosure are further illustrated by and described with reference to apparatus diagrams, system diagrams, and flowcharts that relate to tenant-specific user management within multi-tenant applications.

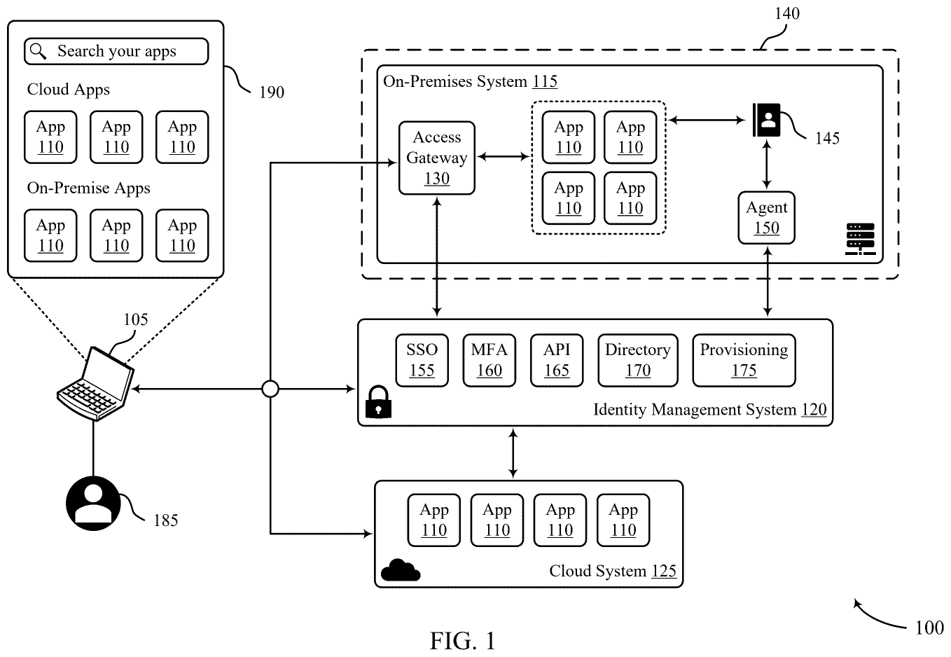

FIG. 1 illustrates an example of a computing system 100 that supports tenant-specific user management within multi-tenant applications in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

In some examples of the computing system 100, tenants (e.g., organizations) of multi-tenant applications 110 may utilize an IdP as the identity management system 120 to manage user data and provide authentication services for the multi-tenant applications 110. In some examples, a tenant may utilize a SSO service 155 or MFA service 160 for users to access multi-tenant applications 110 and the identity management system 120 may exchange user management data with the multi-tenant applications 110 via the IdP of a tenant. For example, a tenant may utilize the IdP to automate the exchange of identity information for users associated with the tenant (e.g., the organization). Further, in some examples, the IdP may use the identity management protocol or exchange system to support the provisioning service 175. For example, if a user is added to the organization and the IdP receives identity information for the user, the IdP may use the provisioning service 175 to automatically exchange the identity information with an application to create an account for the user. However, in some examples, an identity management protocol or exchange system utilized by the IdP of an organization and the application may be different. In some cases, the computing system 100 may implement mappings for each tenant. For example, the computing system 100 may implement a mapping of a first set of user attributes used by the provisioning service 175 of the identity management system 120 for a tenant to a second set of user attributes used by an authentication system associated with a multi-tenant application 110. However, as the quantity of tenants that utilize a multi-tenant application 110 may be relatively large, the computing system 100 may have to implement a relatively large quantity of mappings to enable user identity information exchanges between identity management systems 120 of tenants and the multi-tenant applications 110. Further, implementing a relatively large quantity of mappings between tenants and multi-tenant applications 110 may result in a relatively high level of resource consumption for the computing system 100.

In accordance with the techniques of the present disclosure, to provide tenants a secure approach for using the provisioning service 175, the computing system 100 may establish connections and attribute mappings on a per IdP basis rather than a per tenant basis. For example, an application 110 (e.g., a multi-tenant application 110) may establish a first connection with a first IdP that is associated with and provides an identity management system 120 to multiple different tenants (e.g., organizations). Moreover, a user 185 (e.g., a developer or administrator) associated with the application may implement a mapping between a first set of attributes (e.g., user attributes within user management messages) associated with the first IdP and a second set of attributes associated with the authentication system of the application 110 (e.g., user attributes used to store data for tenants of the application 110). The application may then receive an indication of the mapping (e.g., the attribute mapping) and transmit the mapping to the authentication system of the application 110. Further, when the authentication system of the application 110 receives a request message from a tenant of the first IdP (e.g., a user management message), the authentication system may use the attribute mapping to map the data from the request message from being within the first set of attributes to being within the second set of attributes. Moreover, the authentication system may then be enabled to use the data and store the data from the request message within a tenant-specific data store at the application 110. Thus, the techniques of the present disclosure may enable an identity management system 120 to support a provisioning service 175 for tenants of a multi-tenant application by implementing per IdP attribute mappings for request messages from tenants supported by IdPs. Moreover, the per IdP attribute mappings described in accordance with the techniques of the present disclosure may result in a more efficient, accurate, and reliable user management exchange process and a decrease in resource consumption for the computing system 100.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

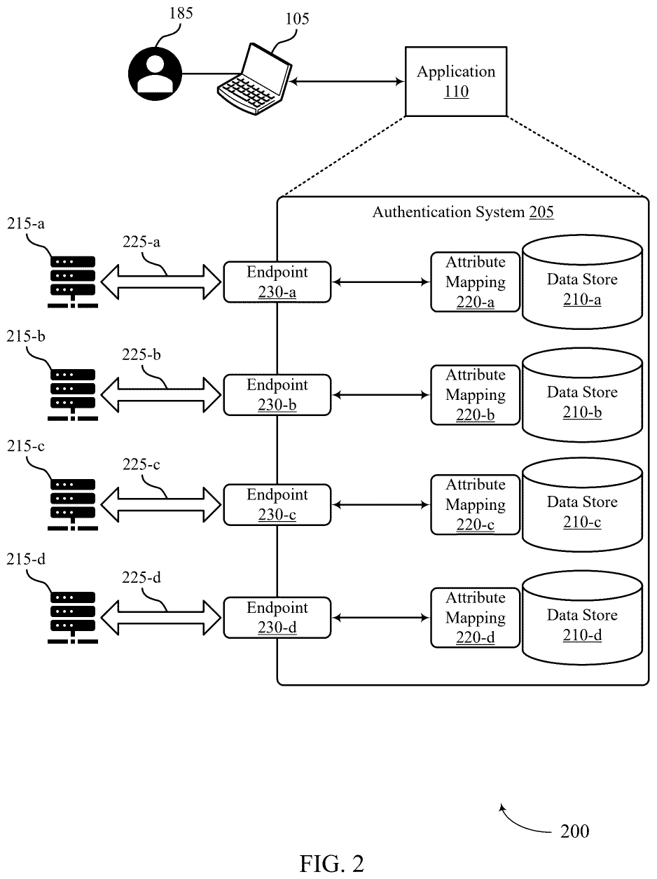

FIG. 2 shows an example of a computing system 200 that supports tenant-specific user management within multi-tenant applications in accordance with aspects of the present disclosure. In some examples, the computing system 200 may implement or be implemented by the computing system 100. For example, the computing system 200 may include a computing device 105 that a user 185 can use to access an application 110, which may be examples of devices or services described with reference to FIG. 1. In some cases, the user 185 may be an example of a developer of the application 110 that manages and configures the application 110. In some other cases, the user 185 may be an example of an end-user that utilizes the application 110 based on the configurations of the application 110 generated and managed by a developer of the application 110. Further, in some examples, the application 110 may be associated with an authentication system 205 that may be an example of an identity management system 120 described with reference to FIG. 1.

In some examples of the computing system 200, the application 110 may be an example of a multi-tenant application 110. For example, multiple different tenants or organizations that each include sets of users 185 may utilize the application 110. In some examples, a multi-tenant application 110 may be associated with an authentication system 205 to govern, collect, analyze, and store user 185 data for tenants. In some cases, the authentication system 205 may also have one or more data stores 210 (e.g., a data store 210-a, a data store 210-b, a data store 210-c, and a data store 210-d) that are isolated from each other to separate tenant-specific data. That is, each tenant (e.g., organization) utilizing the application 110 may have a different data store 210 within the authentication system 205 associated with the application 110.

In some cases, to manage user 185 data a tenant or organization may implement an identity management system 120 via an IdP 215 (e.g., an IdP 215-a, an IdP 215-b, an IdP 215-c, and an IdP 215-d). In some examples, a respective IdP 215 may manage user 185 data and identity information for a tenant to access various applications 110 (e.g., multi-tenant applications 110). For example, a first tenant may utilize the IdP 215-a to manage user 185 data and identity information for one or more applications accessible to the users 185 of the first tenant. Further, a respective IdP 215 may be associated with various different tenants. For example, a first tenant and a second tenant may both use the IdP 215-a to manage the user 185 data and identity information for the respective tenant. Additionally, or alternatively, the IdPs 215 may be referred to as identity and access management (IAM) service providers

In some examples, a respective tenant my utilize the respective IdP 215 to automate the management of user 185 accounts stored in the application 110. For example, when a tenant or organization adds one or more users 185 to a set of users 185 associated with the tenant, accounts for the one or more users 185 may have to be generated within the application 110. In some cases, as the quantity of users 185 associated with a tenant may be relatively large, having an IdP 215 automate the management of user 185 accounts for the tenants of the application 110 may improve the security and efficiency of user data management for the tenant. Therefore, when the one or more users 185 are added to the set of users 185 associated with the tenant, the respective IdP 215 may access the user 185 data stored for the tenant and exchange the user 185 data and identity information with the application 110 to create accounts for the users 185 based on the roles, permissions, and parameters associated with the one or more users 185. For example, a first user 185 may be a manager and may be given more privileges within the application 110 than a second user 185 and the respective IdP 215 may automatically communicate such information to the authentication system 205 of the application 110 to generate accounts for the users 185. Additionally, or alternatively, for tenants that utilize a SSO service 155 to allow users 185 to access multiple applications 110 with a single set of credentials, the respective IdP 215 for a tenant and the authentication system 205 of the application 110 may generate an account for users 185 and enable the users 185 to access the account of the application 110 via the SSO service 155.

To exchange the information for user 185 management between an IdP 215 and the authentication system 205 associated with the application 110, the IdP 215 of a tenant and the authentication system 205 may utilize a protocol that is associated with automating the exchange of user 185 identity information. For example, the IdP 215 of a tenant and the authentication system 205 associated with the application 110 may utilize a system for cross-domain management (SCIM) protocol that can create, update, activate, deactivate, and delete user 185 accounts with the application 110. Further, the SCIM protocol may provide tenants with a secure procedure of exchanging user 185 identity information between an IdP 215 and an application 110 utilized by users 185 associated with a tenant. In some cases, using protocols like SCIM may further enhance the efficiency of user management by reducing the time-consumption for system administrator users 185. Moreover, having the user 185 management be automated for a tenant via SCIM may improve the security of a tenant and the data associated with the tenant within various applications.

In some cases, when utilizing the SCIM protocol an IdP 215 (e.g., the IdP 215-a) and the authentication system 205 may use different sets of attributes to transmit and store user 185 data. For example, the IdP 215-a that is utilized by one or more tenants may use a first set of user 185 attributes for an API user 185 schema and the authentication system 205 may use a second set of user 185 attributes for an authentication user 185 schema. That is, when a first tenant transmits user 185 management messages via an API message, the first tenant may transmit the user 185 data within a first set of user 185 attributes and the authentication system 205 may use a second set of user 185 attributes that is different from the first set of user 185 attributes to store the user 185 data within the data store 210-a that is associated with the first tenant. For example, when a user 185 is added to the first tenant, the tenant may transmit an API message (e.g., utilizing the API service 165 described with reference to FIG. 1) to the authentication system 205 of the application 110 that includes user 185 data and identity information of the user 185 according to a user 185 schema that includes a first set of attributes. For example, the first set of attributes of the user 185 schema supported by the first tenant may include a username attribute, an email attribute, an external identifier attribute, and one or more other attributes that identify the user 185 data and identify information of a new user 185 for the first tenant. However, the user 185 schema used by the authentication system 205 to store user 185 data for the first tenant within data store 210 (e.g., the data store 210-a) may include a different set of attributes than the set of attributes used by the API message from the first tenant. For example, the attributes may be named differently, the attributes may expect different parameters or values, the authentication system 205 may have one or more additional attributes or one or more less attributes than those included in API message from the first tenant, or any combination thereof.

Therefore, in some cases, a user 185 of the application 110 (e.g., a developer of a multi-tenant application 110) may generate attribute mappings 220 for tenants to map the set of attributes of an API message from a tenant to the set of attributes used by the authentication system 205. Additionally, or alternatively, based on the attribute mapping 220, the authentication system 205 may ignore any attributes included in an API call that are unsupported by the authentication system 205. However, as the quantity of tenants that utilize a multi-tenant application 110 may be relatively large and may increase, having a developer user 185 implement an attribute mapping 220 for each tenant may be relatively inefficient and time-consuming and may result in a relatively high level of resource consumption.

In accordance with the techniques of the present disclosure, a developer of the application 110 (e.g., a user 185 that configures and manages the application) may implement a set of attribute mappings 220 (e.g., an attribute mapping 220-a, an attribute mapping 220-b, an attribute mapping 220-c, and an attribute mapping 220-d) for each IdP 215 rather than for each tenant. For example, multiple tenants may use the same IdP 215 to automate the exchange of user 185 data and identity information between the respective tenant and the authentication system 205 of the application 110, and thus implementing attribute mappings 220 between an IdP 215 and the authentication system 205 may be relatively more efficient and may reduce the resource consumption associated with implementing attribute mappings 220.

In some examples, when a first tenant determines to use the application 110, the application 110 may establish a connection 225 between the IdP 215-a (e.g., a first IdP) and the authentication system 205 that is associated with the application 110, where the IdP 215-a may be associated with one or more tenants including the first tenant. Moreover, the application 110 may establish a set of connections 225 for a set of IdPs 215 used by tenants that utilize the application 110. For example, the application 110 may establish a connection 225-a between the IdP 215-a and the authentication system 205 for a first set of tenants supported by the IdP 215-a, a connection 225-b between the IdP 215-b and the authentication system 205 for a second set of tenants supported by the IdP 215-b, a connection 225-c between the IdP 215-c and the authentication system 205 for a third set of tenants supported by the IdP 215-c, and a connection 225-d between the IdP 215-d and the authentication system 205 for a fourth set of tenants supported by the IdP 215-d.

Moreover, establishing a respective connection 225 may also include establishing, at the authentication system 205, an endpoint 230 (e.g., an endpoint 230-a, an endpoint 230-b, an endpoint 230-c, and an endpoint 230-d) for request messages from tenants of a respective IdP 215. For example, the IdP 215-a may transmit API calls to the authentication system 205 via the connection 225-a to the endpoint 230-a for a tenant supported by the IdP 215-a. In some examples, the endpoints 230 may be specific to the IdPs 215 or to the tenants supported by the IdPs 215. For example, in some cases, the authentication system 205 may have an endpoint 230 for each tenant that utilizes the application 110 and a respective endpoint 230 for a respective tenant may point to a data store 210 for the respective tenant. For example, the endpoint 230-a may be associated with a first tenant and may connect the first tenant to the data store 210-a of the authentication system 205 that is associated with the first tenant. In some other cases, the authentication system 205 may have an endpoint 230 for each IdP 215 that tenants of the application 110 utilize and the endpoint 230 for a respective IdP 215 may point to one or more data stores 210 based on the tenants supported by the respective IdPs 215.

Therefore, each IdP 215 or tenant may be configured with an endpoint 230 that is dedicated for user 185 management and with credentials to allow the respective IdP 215, tenant, or both, to provision, de-provision, and manage user 185 accounts associated with the respective IdP 215, tenant, or both stored inside respective data stores 210 inside the authentication system 205. In some examples, the form of the endpoint 230 may indicate a tenant name and a connection identifier to enable the authentication system 205 to know which data store 210 and respective tenant an endpoint 230 is associated with. Further, each endpoint 230 may be a tenant-specific user 185 management endpoint that reads and writes user 185 data to a data store 210 that is secure and internal to the authentication system 205 of the application 110. Moreover, since each data store 210 is isolated from each other, API clients (e.g., tenants) using a tenant-specific endpoint may be unable to read or write to a data store 210 of another tenant. For example, a developer of the application 110 may configure the IdP 215-a with a connection-specific endpoint (e.g., the endpoint 230-a) and with an authentication token that allows the IdP 215-a to provision, de-provision, and manage user 185 accounts stored in data stores 210 of the authentication system 205 that are associated with tenants that the IdP 215-a supports.

Moreover, as illustrated in FIG. 2, the IdP 215-a may have the connection 225-a to the authentication system 205 via the endpoint 230-a to allow provisioning, de-provisioning, and management of user 185 accounts stored within the data store 210-a that may be specific to a first tenant. However, it should be understood by one of ordinary skill in the art that the endpoint 230-a may enable the IdP 215-a to provision, deprovision, and manage user 185 account data stored within other data stores 210 associated with and specific to each tenant that the IdP 215-a supports as each tenant may be associated with an individual data store 210 within the authentication system 205 to isolate tenant-specific data thus enhancing the security of the data for a respective tenant within the authentication system 205 of the application 110.

Further, as described herein, each endpoint 230 may be configured to support one or more authentication tokens (e.g., up to two unique bearer tokens) for user 185 management operations thus allowing a client's (e.g., a tenant's) token to be updated without downtime. Moreover, in some cases, the tokens may be configured to expire after a quantity of seconds has elapsed since the creation of the token. Further, the application 110 may configure the connections 225 between the IdPs 215 and the authentication system 205 with a set of operation (e.g., user 185 account management operations) for a respective tenant of the one or more tenants supported by a respective IdP 215 (e.g., the IdP 215-a). That is, for each token, the user 185 (e.g., the developer) of the application 110 can authorize one or more user 185 management operations for respective tenants of IdPs 215. For example, an authentication token can authorize a data retrieval operation (e.g., a get operation) to allow users 185 to be retrieved and searched, a data storage operation (e.g., a post operation) to allow users 185 to be created (e.g., allow accounts for users 185 to be created for the application 110), a data update operation (e.g., a put operation or a patch operation) to allow users 185 (e.g., user 185 accounts) to be updated using the PUT or PATCH method, a data removal operation (e.g., a delete operation) to allow users 185 to be deleted (e.g., to delete user 185 accounts for the application 110), or any combination thereof. Additionally, or alternatively, the endpoints 230 and tokens for the IdPs 215 may be visible and configurable by a user 185 (e.g., a developer) associated with the application 110 via a user interface or dashboard at the application 110.

Based on establishing the connection 225-a between the IdP 215-a and the authentication system 205 and establishing the endpoint 230-a, the application 110 may receive, from a first developer associated with the application 110 (e.g., a developer user 185 associated with the application 110 operating a computing device 105 to configure the application 110), an indication of a mapping (e.g., an attribute mapping 220) between a first set of attributes associated with the IdP 215-a (e.g., a first IdP 215) and a second set of attributes associated the authentication system 205. For example, a developer (e.g., a business to business (B2B) software as a service (SaaS) or multi-tenant application 110 developer user 185) may configure an attribute mapping 220 between an API user schema and a user 185 schema used by the authentication system 205 on a per-connection basis. That is, the user 185 associated with the application 110 may generate and implement an attribute mapping 220 for each respective connection 225 between a respective IdP 215 and the authentication system 205. Additionally, or alternatively, the developer may generate and implement the attribute mappings 220 during an establishment of a SSO service and an integration of a provisioning service (e.g., the SSO service 155 and the provisioning service 175 described with reference to FIG. 1) for the respective IdPs 215 and prior to any end-users of the application 110 signing in or accessing the application 110 via the respective IdPs 215. Therefore, by implementing the attribute mapping 220, the developer of the application 110 may thus be able to flexibly adapt in-bound user attributes from a tenant to the user 185 attributes stored in the authentication system 205.

Moreover, implementing the attribute mappings 220 on a per-connection basis (e.g., for each connection 225 between an IdP 215 and the authentication system 205), the administrators, developers, or both may also address provisioning client compatibility issues on a per-tenant basis. For example, having an attribute mapping 220 between a respective IdP 215 that serves multiple tenants and the authentication system 205 may solve both attribute incompatibility issues for each tenant served by the respective IdP 215. Thus, in accordance with the techniques of the present disclosure, implementing the attribute mappings 220 may allow for inbound user 185 attributes from an API call of a tenant (e.g., a SCIM API call) to be mapped to a target application 110 user attributes. Moreover, a collection of inbound user 185 attributes specified in a respective attribute mapping 220 may become an effective set of user 185 attributes for a respective endpoint 230 such that each endpoint 230 has a set of supported attributes.

Therefore, the techniques of the present disclosure may enable a multi-tenant application 110 to support user 185 management (e.g., user 185 management APIs) for each of the tenants of the application 110 where each tenant is operated by a customer or subscriber of the application (e.g., an IdP 215). For example, utilizing a connection 225 between an IdP 215 and the authentication system 205 of the application, the authentication system 205 may be capable of receiving user 185 management API messages and storing data within a data store 210 that is tenant-specific, querying the data store 210, or both. For example, to create an account for a new user 185 of a first tenant, the first tenant, via the IdP 215-a of the first tenant and the connection 225-a, may transmit a request message (e.g., an API message) with a set of data of the new user 185 to the endpoint 230-a at the authentication system 205. Then, in accordance with the techniques of the present disclosure, the authentication system 205 may apply the attribute mapping 220-a and map the set of data of the request message from the first set of attributes associated with the IdP 215-a of the first tenant to the second set of attributes of the authentication system 205. Further, based on mapping the data to the second set of attributes, the authentication system 205 may store the set of data within a data store 210-a that is associated with and specific for the first tenant.

In another example, the first tenant may transmit a second request message indicating a request to read a second set of data from the data store 210-a at the authentication system 205 that is associated with the first tenant and the second request message may include an indication of the second set of data using the first set of attributes. The authentication system 205 may then receive the second request message at the endpoint 230-a via the connection 225-a and map the second set of data from the first set of attributes to the second set of attributes. Thus, based on the mapping, the authentication system 205 may then be capable of querying the data store 210-a for the data requested by the first tenant. Further, once the authentication system 205 obtains the requested data, the authentication system 205 may map the obtained data to the first set of attributes in accordance with the attribute mapping 220-a to then transmit a response message to the first tenant indicating the requested and obtained data.

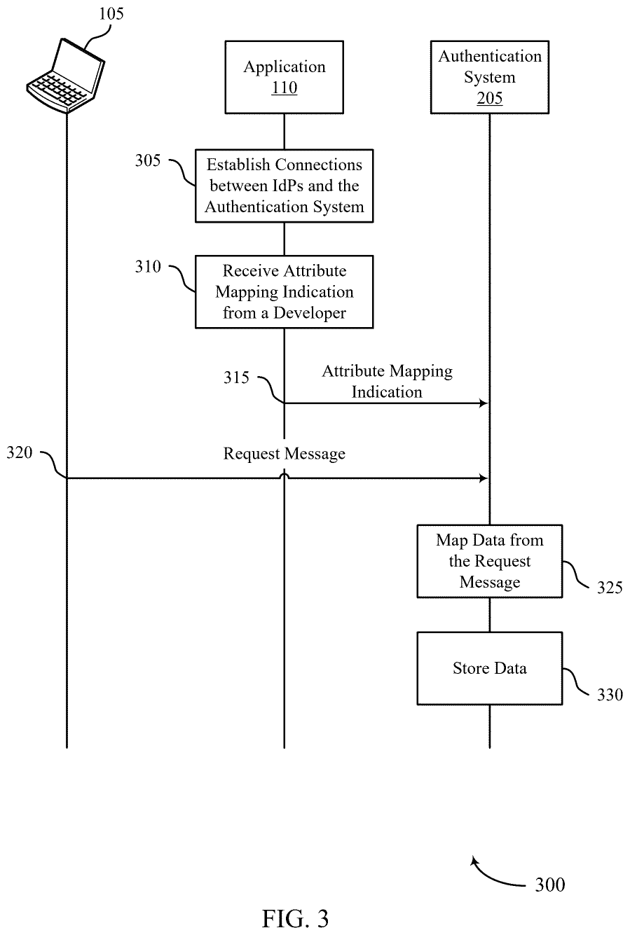

Thus, the techniques of the present disclosure may enable developers of applications 110 to offer user 185 provisioning to IdPs 215 and respective tenants in a secure, flexible, and compatible fashion. For example, the techniques of the present disclosure may ensure that API messages for user 185 management from tenants can be handled at the authentication system 205 using secure and efficient techniques that allow tenants to use IdPs 215 to automate user 185 management for the tenant, thus improving the security and efficiency of user 185 management for tenants utilizing multi-tenant applications. Further descriptions of the techniques of the present disclosure may be described elsewhere herein, such as with reference to FIG. 3.

FIG. 3 shows an example of a process flow 300 that supports tenant-specific user management within multi-tenant applications in accordance with aspects of the present disclosure. In some examples, the process flow 300 may implement or may be implemented by the computing system 100, the computing system 200, or a combination thereof. The process flow 300 may include a computing device 105, an application 110, and the authentication system 205, which may be examples of devices or services described elsewhere herein including with reference to FIG. 1.

In the following description of the process flow 300, the operations may be performed by the computing device 105, the application 110, and the authentication system 205 in different orders or at different times. Some operations may also be left out of the process flow 300, or other operations may be added. Although the process flow 300 may be described as being performed by the computing device 105, the application 110, and the authentication system 205, some aspects of some operations may also be performed by other devices, services, or models described elsewhere herein including with reference to FIGS. 1 through 2.

At 305, the application may establish a first connection between a first IdP and an authentication system 205 associated with application 110. The first IdP may be associated with one or more tenants. In some examples, the application 110 may configure the first connection with a set of operations for a respective tenant of the one or more tenants. The set of operations may include a data retrieval operation, a data storage operation, a data update operation, a data removal operation, or any combination thereof. In some other examples, the application 110 may establish an endpoint at the authentication system 205 for one or more request messages from the first tenant. The endpoint may be associated with the first tenant. In some cases, the application 110 may configure the endpoint to support one or more authentication tokens. Additionally, or alternatively, the endpoint may connect the first tenant to a data store of the authentication system 205 that is associated with the first tenant. In some other cases, the first IdP may be included within a set of IdPs that are associated with different sets of one or more tenants. Further, the first connection may be included within a set of connections between respective IdPs and the authentication system 205.

At 310, the application 110 may receive, from a first developer operating a computing device 105 associated with application 110, an indication of a mapping between a first set of attributes associated with the first IdP and a second set of attributes associated with the authentication system 205 may be received. In some examples, the first developer (e.g.,. a user 185 that configures and manages the application 110) may be included within a set of developers associated with application 110. Further, the attributes of the first set of attributes associated with the first IdP may be API schema attributes.

At 315, the application 110 may transmit the indication of the mapping to the authentication system 205. A data store of the authentication system 205 may use the mapping to store data from one or more request messages. The data store may be associated with the first tenant. In some examples, the one or more request messages may be user management request messages and the data from the one or more request messages may include user management data. Moreover, the data store associated with the first tenant may be associated with the user management data for one or more users associated with the first tenant. Further, the authentication system 205 may include a set of data stores for the one or more tenants that includes the data store associated with the first tenant.

Thus, at 315, the authentication system 205 may receive, for a first connection between a first IdP and an application 110 associated with the authentication system 205, an indication of a mapping between a first set of attributes associated with the first IdP and a second set of attributes associated with the authentication system 205. The first IdP may be associated with one or more tenants. In some examples, the indication of the mapping may include an indication of a mapping between a first set of user schema attributes of an API message and a second set of user schema attributes of a data store associated with the authentication system 205. The first set of attributes may include the first set of user schema attributes and the second set of attributes may include the second set of user schema attributes.

At 320, the authentication system 205 may receive, from a first tenant of the one or more tenants associated with the first IdP, a request message that includes a set of data associated with the first set of attributes. In some cases, the request message may be received via an endpoint at the authentication system 205 for one or more request messages from the first tenant, where the endpoint is associated with the first tenant. Further, the request message may include an authentication token from the first tenant, and a mapping of the set of data of the request message to the second set of attributes associated with the authentication system 205 may be based on authenticating the authentication token from the first tenant. Additionally, or alternatively, the request message may indicate a request for the authentication system 205 to execute one or more operations, which may include a data retrieval operation, a data storage operation, a data update operation, a data removal operation, or any combination thereof. In some examples, the request message may also be associated with user management between the first tenant and the authentication system 205.

At 325, in response to receiving the request message, the authentication system 205 may map the set of data of the request message to the second set of attributes associated with the authentication system 205 in accordance with the indication of the mapping for the first connection. In some examples, the set of data associated with the first set of user schema attributes of the API message may be mapped to the second set of user schema attributes of the authentication system 205.

At 330, the authentication system 205 may store the set of data from the request message in a data store associated with the authentication system 205 based on mapping the set of data of the request message to the second set of attributes associated with the authentication system 205. Moreover, the data store may be associated with the first tenant.

In some examples, the authentication system 205 may receive, from the first tenant, a second request message indicating a request to read a second set of data from the data store at the authentication system 205 that is associated with the first tenant. The second request message may include an indication of the second set of data associated with the first set of attributes. In response to receiving the second request message, the authentication system 205 may map the second set of data of the request message to the second set of attributes associated with the authentication system 205 in accordance with the indication of the mapping for the first connection. The authentication system 205 may then query the data store associated with the first tenant for the second set of data that is associated with the second set of attributes to obtain the second set of data from the data store. In response to obtaining the second set of data from the data store, the authentication system 205 may map the second set of data obtained from the data store to the first set of attributes associated with the first IdP. The authentication system 205 may then transmit, to the first tenant, a response message that includes the second set of data requested via the second request message. The second set of data may be associated with the first set of attributes, and the response message may be transmitted based on obtaining the second set of data and mapping the second set of data to the first set of attributes.

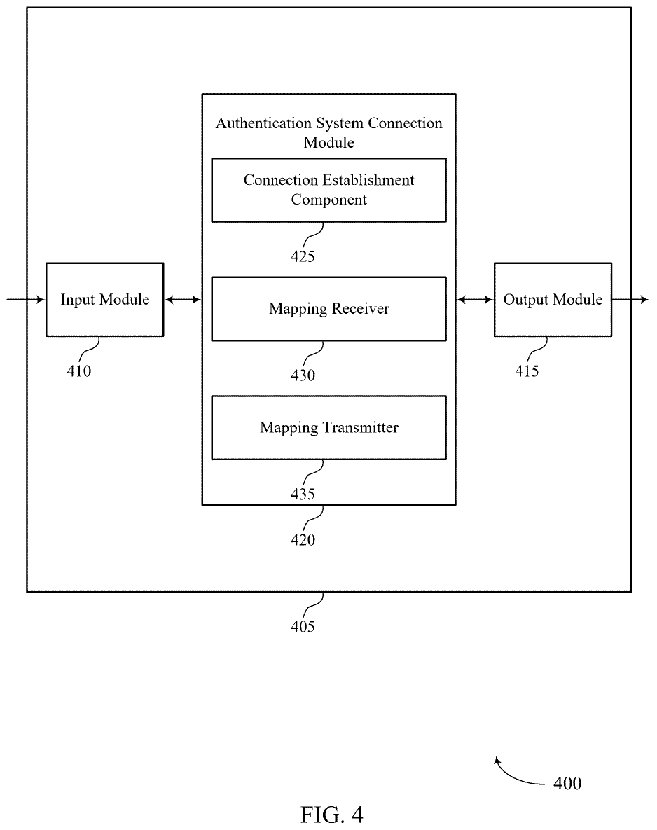

FIG. 4 shows a block diagram 400 of a device 405 that supports tenant-specific user management within multi-tenant applications in accordance with aspects of the present disclosure. The device 405 may include an input module 410, an output module 415, and an authentication system connection module 420. The device 405, or one or more components of the device 405 (e.g., the input module 410, the output module 415, the authentication system connection module 420), may include at least one processor, which may be coupled with at least one memory, to support the described techniques. Each of these components may be in communication with one another (e.g., via one or more buses).

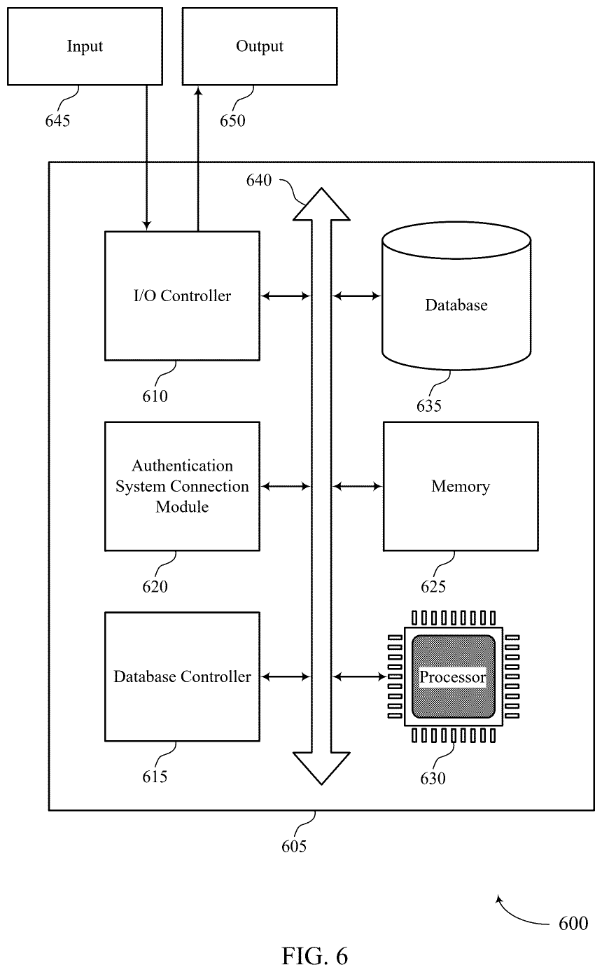

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the authentication system connection module 420 to support tenant-specific user management within multi-tenant applications. In some cases, the input module 410 may be a component of an input/output (I/O) controller 610 as described with reference to FIG. 6.

The output module 415 may manage output signals for the device 405. For example, the output module 415 may receive signals from other components of the device 405, such as the authentication system connection module 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the authentication system connection module 420 may include a connection establishment component 425, a mapping receiver 430, a mapping transmitter 435, or any combination thereof. In some examples, the authentication system connection module 420, or various components thereof, may be configured to perform various operations (e.g., receiving, monitoring, transmitting) using or otherwise in cooperation with the input module 410, the output module 415, or both. For example, the authentication system connection module 420 may receive information from the input module 410, send information to the output module 415, or be integrated in combination with the input module 410, the output module 415, or both to receive information, transmit information, or perform various other operations as described herein.

The authentication system connection module 420 may support user management in accordance with examples as disclosed herein. The connection establishment component 425 may be configured to support establishing a first connection between a first identity provider and an authentication system associated with the application, the first identity provider associated with one or more tenants. The mapping receiver 430 may be configured to support receiving, from a first developer associated with the application, an indication of a mapping between a first set of attributes associated with the first identity provider and a second set of attributes associated with the authentication system. The mapping transmitter 435 may be configured to support transmitting, to the authentication system, the indication of the mapping, where a data store of the authentication system stores data from one or more request messages in accordance with the mapping, the data store being associated with a first tenant of the one or more tenants.

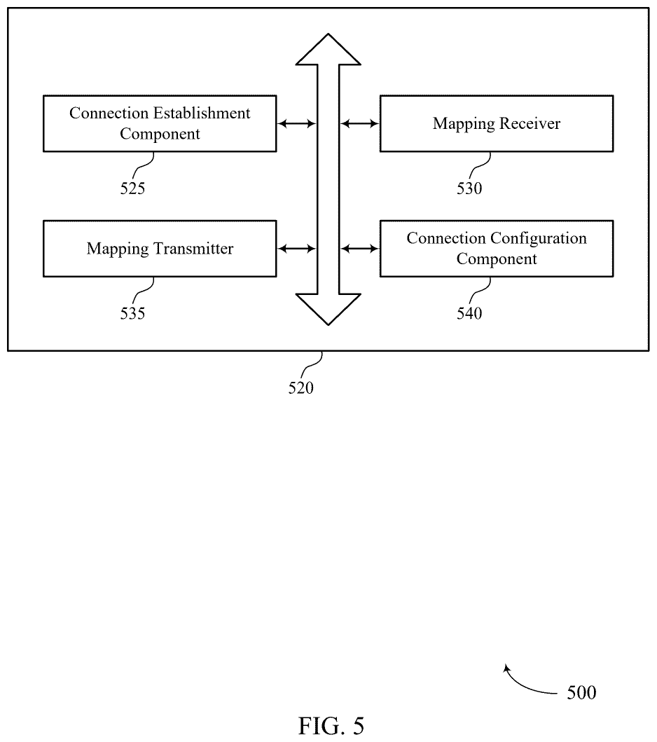

FIG. 5 shows a block diagram 500 of an authentication system connection module 520 that supports tenant-specific user management within multi-tenant applications in accordance with aspects of the present disclosure. The authentication system connection module 520 may be an example of aspects of an authentication system connection module or an authentication system connection module 420, or both, as described herein. The authentication system connection module 520, or various components thereof, may be an example of means for performing various aspects of tenant-specific user management within multi-tenant applications as described herein. For example, the authentication system connection module 520 may include a connection establishment component 525, a mapping receiver 530, a mapping transmitter 535, a connection configuration component 540, or any combination thereof. Each of these components, or components of subcomponents thereof (e.g., one or more processors, one or more memories), may communicate, directly or indirectly, with one another (e.g., via one or more buses).

The authentication system connection module 520 may support user management in accordance with examples as disclosed herein. The connection establishment component 525 may be configured to support establishing a first connection between a first identity provider and an authentication system associated with the application, the first identity provider associated with one or more tenants. The mapping receiver 530 may be configured to support receiving, from a first developer associated with the application, an indication of a mapping between a first set of attributes associated with the first identity provider and a second set of attributes associated with the authentication system. The mapping transmitter 535 may be configured to support transmitting, to the authentication system, the indication of the mapping, where a data store of the authentication system stores data from one or more request messages in accordance with the mapping, the data store being associated with a first tenant of the one or more tenants.

In some examples, the connection configuration component 540 may be configured to support configuring the first connection between the first identity provider and the authentication system with a set of operations for a respective tenant of the one or more tenants, the one or more request messages in accordance with the set of operations.

In some examples, the set of operations includes a data retrieval operation, a data storage operation, a data update operation, a data removal operation, or any combination thereof.

In some examples, to support establishing the first connection, the connection establishment component 525 may be configured to support establishing, at the authentication system, an endpoint for the one or more request messages from the first tenant, the endpoint associated with the first tenant.

In some examples, to support establishing the endpoint, the connection establishment component 525 may be configured to support configuring the endpoint to support one or more authentication tokens.

In some examples, the endpoint connects the first tenant to the data store of the authentication system that is associated with the first tenant.

In some examples, attributes of the first set of attributes associated with the first identity provider are application programming interface (API) schema attributes.

In some examples, the one or more request messages are user management request messages, the data from the one or more request messages includes user management data, and the data store associated with the first tenant is associated with the user management data for one or more users associated with the first tenant.

In some examples, the authentication system includes a set of multiple data stores for the one or more tenants that includes the data store associated with the first tenant, the first identity provider is included within a set of multiple identity providers that are associated with different sets of one or more tenants, and the first connection is included within a set of multiple connections between respective identity providers and the authentication system.

FIG. 6 shows a diagram of a system 600 including a device 605 that supports tenant-specific user management within multi-tenant applications in accordance with aspects of the present disclosure. The device 605 may be an example of or include components of a device 405 as described herein. The device 605 may include components for bi-directional voice and data communications including components for transmitting and receiving communications, such as an authentication system connection module 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting tenant-specific user management within multi-tenant applications). The processor 630 may be an example of a single processor or multiple processors. For example, the device 605 may include one or more processors 630.

The authentication system connection module 620 may support user management in accordance with examples as disclosed herein. For example, the authentication system connection module 620 may be configured to support establishing a first connection between a first identity provider and an authentication system associated with the application, the first identity provider associated with one or more tenants. The authentication system connection module 620 may be configured to support receiving, from a first developer associated with the application, an indication of a mapping between a first set of attributes associated with the first identity provider and a second set of attributes associated with the authentication system. The authentication system connection module 620 may be configured to support transmitting, to the authentication system, the indication of the mapping, where a data store of the authentication system stores data from one or more request messages in accordance with the mapping, the data store being associated with a first tenant of the one or more tenants.

By including or configuring the authentication system connection module 620 in accordance with examples as described herein, the device 605 may support techniques for an application to improve user management by establishing connections between IdPs and an authentication system to support improved user management capabilities, improved security, and more efficient user management techniques.

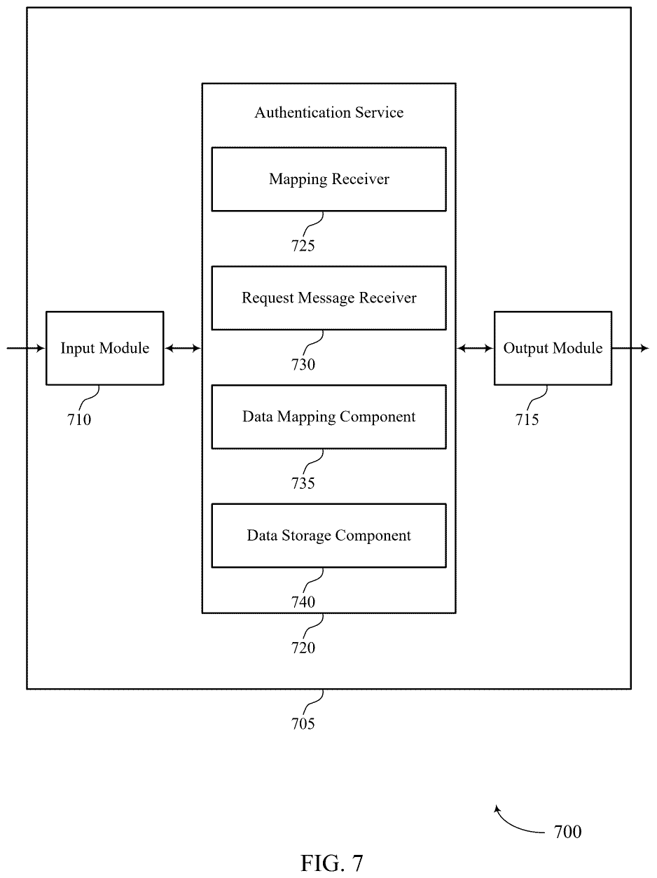

FIG. 7 shows a block diagram 700 of a device 705 that supports tenant-specific user management within multi-tenant applications in accordance with aspects of the present disclosure. The device 705 may include an input module 710, an output module 715, and an authentication service 720. The device 705, or one or more components of the device 705 (e.g., the input module 710, the output module 715, the authentication service 720), may include at least one processor, which may be coupled with at least one memory, to support the described techniques. Each of these components may be in communication with one another (e.g., via one or more buses).

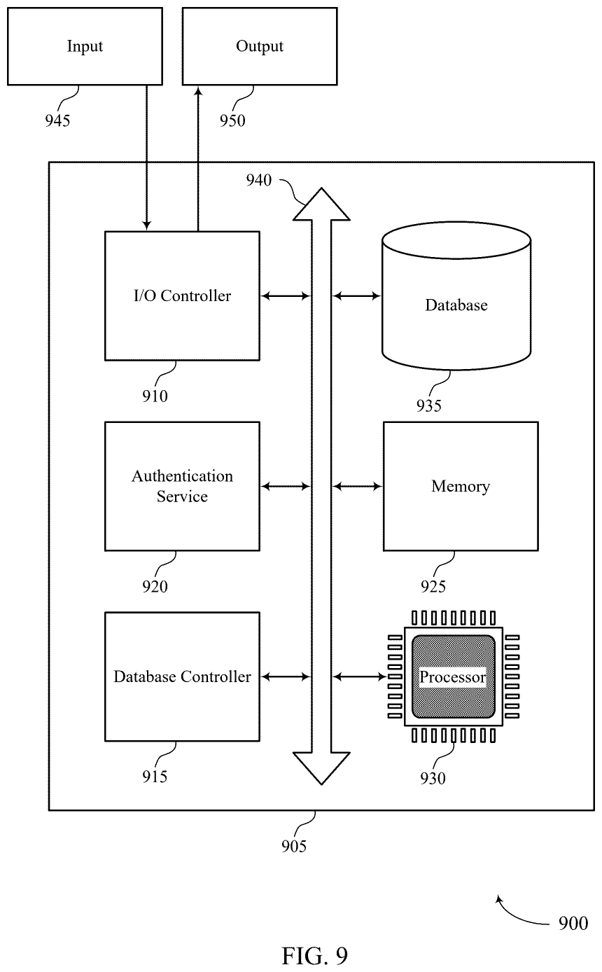

The input module 710 may manage input signals for the device 705. For example, the input module 710 may identify input signals based on an interaction with a modem, a keyboard, a mouse, a touchscreen, or a similar device. These input signals may be associated with user input or processing at other components or devices. In some cases, the input module 710 may utilize an operating system such as iOS®, ANDROID®, MS-DOS®, MS-WINDOWS®, OS/2®, UNIX®, LINUX®, or another known operating system to handle input signals. The input module 710 may send aspects of these input signals to other components of the device 705 for processing. For example, the input module 710 may transmit input signals to the authentication service 720 to support tenant-specific user management within multi-tenant applications. In some cases, the input module 710 may be a component of an input/output (I/O) controller 910 as described with reference to FIG. 9.

The output module 715 may manage output signals for the device 705. For example, the output module 715 may receive signals from other components of the device 705, such as the authentication service 720, and may transmit these signals to other components or devices. In some examples, the output module 715 may transmit output signals for display in a user interface, for storage in a database or data store, for further processing at a server or server cluster, or for any other processes at any number of devices or systems. In some cases, the output module 715 may be a component of an I/O controller 910 as described with reference to FIG. 9.

For example, the authentication service 720 may include a mapping receiver 725, a request message receiver 730, a data mapping component 735, a data storage component 740, or any combination thereof. In some examples, the authentication service 720, or various components thereof, may be configured to perform various operations (e.g., receiving, monitoring, transmitting) using or otherwise in cooperation with the input module 710, the output module 715, or both. For example, the authentication service 720 may receive information from the input module 710, send information to the output module 715, or be integrated in combination with the input module 710, the output module 715, or both to receive information, transmit information, or perform various other operations as described herein.

The authentication service 720 may support user management in accordance with examples as disclosed herein. The mapping receiver 725 may be configured to support receiving, for a first connection between a first identity provider and an application associated with the authentication system, an indication of a mapping between a first set of attributes associated with the first identity provider and a second set of attributes associated with the authentication system, the first identity provider associated with a one or more tenants. The request message receiver 730 may be configured to support receiving, from a first tenant of the one or more tenants associated with the first identity provider, a request message including a set of data associated with the first set of attributes. The data mapping component 735 may be configured to support mapping, in response to receiving the request message, the set of data of the request message to the second set of attributes associated with the authentication system in accordance with the indication of the mapping for the first connection. The data storage component 740 may be configured to support storing the set of data from the request message in a data store associated with the authentication system based on mapping the set of data of the request message to the second set of attributes associated with the authentication system, the data store associated with the first tenant.

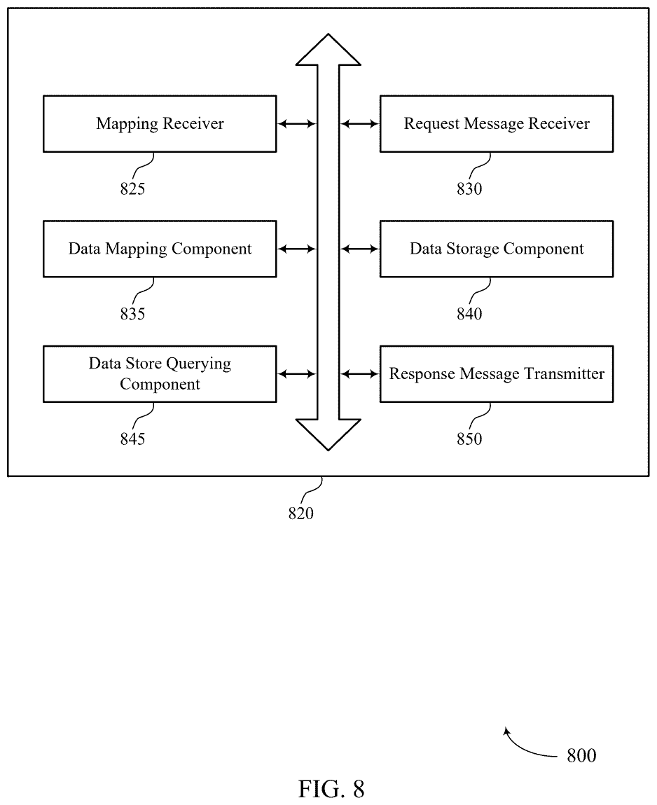

FIG. 8 shows a block diagram 800 of an authentication service 820 that supports tenant-specific user management within multi-tenant applications in accordance with aspects of the present disclosure. The authentication service 820 may be an example of aspects of an authentication service or an authentication service 720, or both, as described herein. The authentication service 820, or various components thereof, may be an example of means for performing various aspects of tenant-specific user management within multi-tenant applications as described herein. For example, the authentication service 820 may include a mapping receiver 825, a request message receiver 830, a data mapping component 835, a data storage component 840, a data store querying component 845, a response message transmitter 850, or any combination thereof. Each of these components, or components of subcomponents thereof (e.g., one or more processors, one or more memories), may communicate, directly or indirectly, with one another (e.g., via one or more buses).

The authentication service 820 may support user management in accordance with examples as disclosed herein. The mapping receiver 825 may be configured to support receiving, for a first connection between a first identity provider and an application associated with the authentication system, an indication of a mapping between a first set of attributes associated with the first identity provider and a second set of attributes associated with the authentication system, the first identity provider associated with a one or more tenants. The request message receiver 830 may be configured to support receiving, from a first tenant of the one or more tenants associated with the first identity provider, a request message including a set of data associated with the first set of attributes. The data mapping component 835 may be configured to support mapping, in response to receiving the request message, the set of data of the request message to the second set of attributes associated with the authentication system in accordance with the indication of the mapping for the first connection. The data storage component 840 may be configured to support storing the set of data from the request message in a data store associated with the authentication system based on mapping the set of data of the request message to the second set of attributes associated with the authentication system, the data store associated with the first tenant.

In some examples, the request message receiver 830 may be configured to support receiving, from the first tenant, a second request message indicating a request to read a second set of data from the data store at the authentication system that is associated with the first tenant, the second request message including an indication of the second set of data associated with the first set of attributes. In some examples, the data mapping component 835 may be configured to support mapping, in response to receiving the second request message, the second set of data of the request message to the second set of attributes associated with the authentication system in accordance with the indication of the mapping for the first connection. In some examples, the data store querying component 845 may be configured to support querying the data store associated with the first tenant for the second set of data that is associated with the second set of attributes to obtain the second set of data from the data store. In some examples, the data mapping component 835 may be configured to support mapping, in response to obtaining the second set of data from the data store, the second set of data obtained from the data store to the first set of attributes associated with the first identity provider. In some examples, the response message transmitter 850 may be configured to support transmitting, to the first tenant, a response message including the second set of data requested via the second request message, the second set of data associated with the first set of attributes, where the response message is transmitted based on obtaining the second set of data and mapping the second set of data to the first set of attributes.

In some examples, to support receiving the request message, the request message receiver 830 may be configured to support receiving the request message via an endpoint at the authentication system for one or more request messages from the first tenant, the endpoint associated with the first tenant.

In some examples, to support receiving the request message, the request message receiver 830 may be configured to support receiving, from the first tenant, an authentication token via the request message, where mapping the set of data of the request message to the second set of attributes associated with the authentication system is based on authenticating the authentication token from the first tenant.

In some examples, to support receiving the indication of the mapping, the mapping receiver 825 may be configured to support receiving, via the indication of the mapping, an indication of a mapping between a first set of user schema attributes of an application programming interface (API) message and a second set of user schema attributes of the data store associated with the authentication system, the first set of attributes including the first set of user schema attributes and the second set of attributes including the second set of attributes, where the request message is an API message.

In some examples, to support mapping the set of data of the request message to the second set of attributes, the data mapping component 835 may be configured to support mapping a set of data associated with the first set of user schema attributes of the API message to the second set of user schema attributes of the authentication system.

In some examples, the request message indicates a request for the authentication system to execute one or more operations, the one or more operations including a data retrieval operation, a data storage operation, a data update operation, a data removal operation, or any combination thereof.

In some examples, the request message is associated with user management between the first tenant and the authentication system.

FIG. 9 shows a diagram of a system 900 including a device 905 that supports tenant-specific user management within multi-tenant applications in accordance with aspects of the present disclosure. The device 905 may be an example of or include components of a device 705 as described herein. The device 905 may include components for bi-directional voice and data communications including components for transmitting and receiving communications, such as an authentication service 920, an I/O controller, such as an I/O controller 910, a database controller 915, at least one memory 925, at least one processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause at least one processor 930 to perform various functions described herein. In some cases, the memory 925 may contain, among other things, a basic I/O system (BIOS) which may control basic hardware or software operation such as the interaction with peripheral components or devices. The memory 925 may be an example of a single memory or multiple memories. For example, the device 905 may include one or more memories 925.

The processor 930 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in at least one memory 925 to perform various functions (e.g., functions or tasks supporting tenant-specific user management within multi-tenant applications). The processor 930 may be an example of a single processor or multiple processors. For example, the device 905 may include one or more processors 930.

The authentication service 920 may support user management in accordance with examples as disclosed herein. For example, the authentication service 920 may be configured to support receiving, for a first connection between a first identity provider and an application associated with the authentication system, an indication of a mapping between a first set of attributes associated with the first identity provider and a second set of attributes associated with the authentication system, the first identity provider associated with a one or more tenants. The authentication service 920 may be configured to support receiving, from a first tenant of the one or more tenants associated with the first identity provider, a request message including a set of data associated with the first set of attributes. The authentication service 920 may be configured to support mapping, in response to receiving the request message, the set of data of the request message to the second set of attributes associated with the authentication system in accordance with the indication of the mapping for the first connection. The authentication service 920 may be configured to support storing the set of data from the request message in a data store associated with the authentication system based on mapping the set of data of the request message to the second set of attributes associated with the authentication system, the data store associated with the first tenant.

By including or configuring the authentication service 920 in accordance with examples as described herein, the device 905 may support techniques for may support techniques for an authentication service to improve user management by utilizing IdP specific endpoints and tenant specific data stores to connect tenants to the authentication system to support improved user management capabilities, improved security, and more efficient user management techniques.

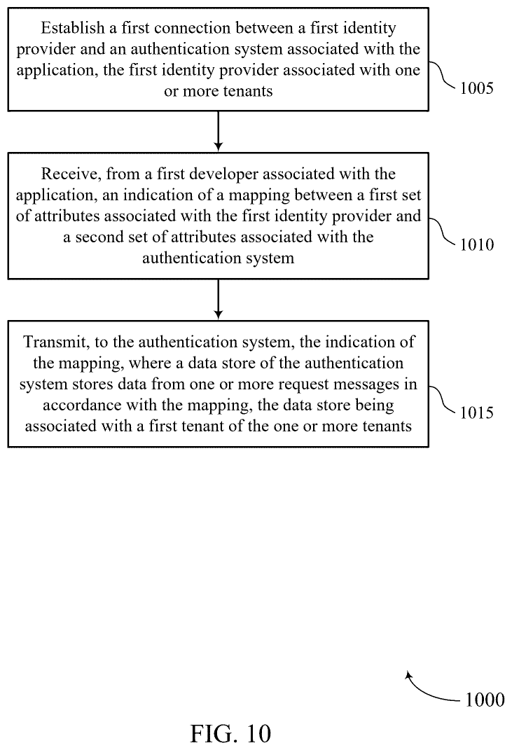

FIG. 10 shows a flowchart illustrating a method 1000 that supports tenant-specific user management within multi-tenant applications in accordance with aspects of the present disclosure. The operations of the method 1000 may be implemented by an application or its components as described herein. For example, the operations of the method 1000 may be performed by an application as described with reference to FIGS. 1 through 6. In some examples, an application may execute a set of instructions to control the functional elements of the application to perform the described functions. Additionally, or alternatively, the application may perform aspects of the described functions using special-purpose hardware.

At 1005, the method may include establishing a first connection between a first identity provider and an authentication system associated with the application, the first identity provider associated with one or more tenants. The operations of 1005 may be performed in accordance with examples as disclosed herein. In some examples, aspects of the operations of 1005 may be performed by a connection establishment component 525 as described with reference to FIG. 5.

At 1010, the method may include receiving, from a first developer associated with the application, an indication of a mapping between a first set of attributes associated with the first identity provider and a second set of attributes associated with the authentication system. The operations of 1010 may be performed in accordance with examples as disclosed herein. In some examples, aspects of the operations of 1010 may be performed by a mapping receiver 530 as described with reference to FIG. 5.

At 1015, the method may include transmitting, to the authentication system, the indication of the mapping, where a data store of the authentication system stores data from one or more request messages in accordance with the mapping, the data store being associated with a first tenant of the one or more tenants. The operations of 1015 may be performed in accordance with examples as disclosed herein. In some examples, aspects of the operations of 1015 may be performed by a mapping transmitter 535 as described with reference to FIG. 5.

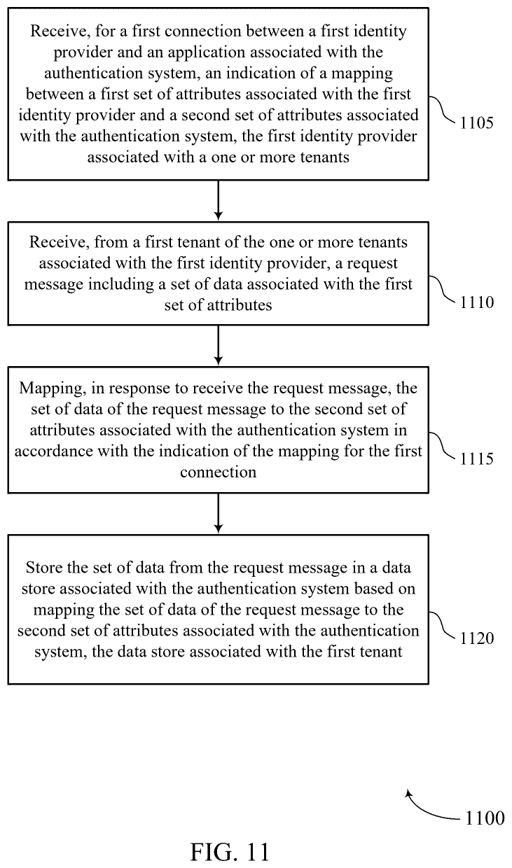

FIG. 11 shows a flowchart illustrating a method 1100 that supports tenant-specific user management within multi-tenant applications in accordance with aspects of the present disclosure. The operations of the method 1100 may be implemented by an authentication system or its components as described herein. For example, the operations of the method 1100 may be performed by an authentication system as described with reference to FIGS. 1 through 3 and 7 through 9. In some examples, an authentication system may execute a set of instructions to control the functional elements of the authentication system to perform the described functions. Additionally, or alternatively, the authentication system may perform aspects of the described functions using special-purpose hardware.

At 1105, the method may include receiving, for a first connection between a first identity provider and an application associated with the authentication system, an indication of a mapping between a first set of attributes associated with the first identity provider and a second set of attributes associated with the authentication system, the first identity provider associated with a one or more tenants. The operations of 1105 may be performed in accordance with examples as disclosed herein. In some examples, aspects of the operations of 1105 may be performed by a mapping receiver 825 as described with reference to FIG. 8.

At 1110, the method may include receiving, from a first tenant of the one or more tenants associated with the first identity provider, a request message including a set of data associated with the first set of attributes. The operations of 1110 may be performed in accordance with examples as disclosed herein. In some examples, aspects of the operations of 1110 may be performed by a request message receiver 830 as described with reference to FIG. 8.

At 1115, the method may include mapping, in response to receiving the request message, the set of data of the request message to the second set of attributes associated with the authentication system in accordance with the indication of the mapping for the first connection. The operations of 1115 may be performed in accordance with examples as disclosed herein. In some examples, aspects of the operations of 1115 may be performed by a data mapping component 835 as described with reference to FIG. 8.

At 1120, the method may include storing the set of data from the request message in a data store associated with the authentication system based on mapping the set of data of the request message to the second set of attributes associated with the authentication system, the data store associated with the first tenant. The operations of 1120 may be performed in accordance with examples as disclosed herein. In some examples, aspects of the operations of 1120 may be performed by a data storage component 840 as described with reference to FIG. 8.

The following provides an overview of aspects of the present disclosure:
Aspect 1: A method for user management by an application, comprising: establishing a first connection between a first identity provider and an authentication system associated with the application, the first identity provider associated with one or more tenants; receiving, from a first developer associated with the application, an indication of a mapping between a first set of attributes associated with the first identity provider and a second set of attributes associated with the authentication system; and transmitting, to the authentication system, the indication of the mapping, wherein a data store of the authentication system stores data from one or more request messages in accordance with the mapping, the data store being associated with a first tenant of the one or more tenants.
Aspect 2: The method of aspect 1, further comprising: configuring the first connection between the first identity provider and the authentication system with a set of operations for a respective tenant of the one or more tenants, the one or more request messages in accordance with the set of operations.
Aspect 3: The method of aspect 2, wherein the set of operations comprises a data retrieval operation, a data storage operation, a data update operation, a data removal operation, or any combination thereof.
Aspect 4: The method of any of aspects 1 through 3, wherein establishing the first connection comprises: establishing, at the authentication system, an endpoint for the one or more request messages from the first tenant, the endpoint associated with the first tenant.
Aspect 5: The method of aspect 4, wherein establishing the endpoint comprises: configuring the endpoint to support one or more authentication tokens.
Aspect 6: The method of any of aspects 4 through 5, wherein the endpoint connects the first tenant to the data store of the authentication system that is associated with the first tenant.
Aspect 7: The method of any of aspects 1 through 6, wherein attributes of the first set of attributes associated with the first identity provider are application programming interface (API) schema attributes.
Aspect 8: The method of any of aspects 1 through 7, wherein the one or more request messages are user management request messages, the data from the one or more request messages comprises user management data, and the data store associated with the first tenant is associated with the user management data for one or more users associated with the first tenant.
Aspect 9: The method of any of aspects 1 through 8, wherein the authentication system comprises a plurality of data stores for the one or more tenants that includes the data store associated with the first tenant, the first identity provider is included within a plurality of identity providers that are associated with different sets of one or more tenants, and the first connection is included within a plurality of connections between respective identity providers and the authentication system.
Aspect 10: A method for user management by an authentication system, comprising: receiving, for a first connection between a first identity provider and an application associated with the authentication system, an indication of a mapping between a first set of attributes associated with the first identity provider and a second set of attributes associated with the authentication system, the first identity provider associated with a one or more tenants; receiving, from a first tenant of the one or more tenants associated with the first identity provider, a request message comprising a set of data associated with the first set of attributes; mapping, in response to receiving the request message, the set of data of the request message to the second set of attributes associated with the authentication system in accordance with the indication of the mapping for the first connection; and storing the set of data from the request message in a data store associated with the authentication system based at least in part on mapping the set of data of the request message to the second set of attributes associated with the authentication system, the data store associated with the first tenant.
Aspect 11: The method of aspect 10, further comprising: receiving, from the first tenant, a second request message indicating a request to read a second set of data from the data store at the authentication system that is associated with the first tenant, the second request message comprising an indication of the second set of data associated with the first set of attributes; mapping, in response to receiving the second request message, the second set of data of the request message to the second set of attributes associated with the authentication system in accordance with the indication of the mapping for the first connection; querying the data store associated with the first tenant for the second set of data that is associated with the second set of attributes to obtain the second set of data from the data store; mapping, in response to obtaining the second set of data from the data store, the second set of data obtained from the data store to the first set of attributes associated with the first identity provider; and transmitting, to the first tenant, a response message comprising the second set of data requested via the second request message, the second set of data associated with the first set of attributes, wherein the response message is transmitted based at least in part on obtaining the second set of data and mapping the second set of data to the first set of attributes.
Aspect 12: The method of any of aspects 10 through 11, wherein receiving the request message comprises: receiving the request message via an endpoint at the authentication system for one or more request messages from the first tenant, the endpoint associated with the first tenant.
Aspect 13: The method of any of aspects 10 through 12, wherein receiving the request message comprises: receiving, from the first tenant, an authentication token via the request message, wherein mapping the set of data of the request message to the second set of attributes associated with the authentication system is based at least in part on authenticating the authentication token from the first tenant.
Aspect 14: The method of any of aspects 10 through 13, wherein receiving the indication of the mapping comprises: receiving, via the indication of the mapping, an indication of a mapping between a first set of user schema attributes of an application programming interface (API) message and a second set of user schema attributes of the data store associated with the authentication system, the first set of attributes comprising the first set of user schema attributes and the second set of attributes comprising the second set of attributes, wherein the request message is an API message.
Aspect 15: The method of aspect 14, wherein mapping the set of data of the request message to the second set of attributes comprises: mapping a set of data associated with the first set of user schema attributes of the API message to the second set of user schema attributes of the authentication system.
Aspect 16: The method of any of aspects 10 through 15, wherein the request message indicates a request for the authentication system to execute one or more operations, the one or more operations comprising a data retrieval operation, a data storage operation, a data update operation, a data removal operation, or any combination thereof.
Aspect 17: The method of any of aspects 10 through 16, wherein the request message is associated with user management between the first tenant and the authentication system.
Aspect 18: An application for user management, comprising one or more memories storing processor-executable code, and one or more processors coupled with the one or more memories and individually or collectively operable to execute the code to cause the application to perform a method of any of aspects 1 through 9.
Aspect 19: An application for user management, comprising at least one means for performing a method of any of aspects 1 through 9.
Aspect 20: A non-transitory computer-readable medium storing code for user management, the code comprising instructions executable by one or more processors to perform a method of any of aspects 1 through 9.
Aspect 21: An authentication system for user management, comprising one or more memories storing processor-executable code, and one or more processors coupled with the one or more memories and individually or collectively operable to execute the code to cause the authentication system to perform a method of any of aspects 10 through 17.
Aspect 22: An authentication system for user management, comprising at least one means for performing a method of any of aspects 10 through 17.
Aspect 23: A non-transitory computer-readable medium storing code for user management, the code comprising instructions executable by one or more processors to perform a method of any of aspects 10 through 17.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for user management by an application, comprising:
establishing a first connection between a first identity provider and an authentication system associated with the application, the first identity provider associated with one or more tenants;
receiving, from a first developer associated with the application, an indication of a mapping between a first set of attributes associated with the first identity provider and a second set of attributes associated with the authentication system; and
transmitting, to the authentication system, the indication of the mapping, wherein a data store of the authentication system stores data from one or more request messages in accordance with the mapping, the data store being associated with a first tenant of the one or more tenants.

2. The method of claim 1, further comprising:
configuring the first connection between the first identity provider and the authentication system with a set of operations for a respective tenant of the one or more tenants, the one or more request messages in accordance with the set of operations.

3. The method of claim 2, wherein the set of operations comprises a data retrieval operation, a data storage operation, a data update operation, a data removal operation, or any combination thereof.

4. The method of claim 1, wherein establishing the first connection comprises:
establishing, at the authentication system, an endpoint for the one or more request messages from the first tenant, the endpoint associated with the first tenant.

5. The method of claim 4, wherein establishing the endpoint comprises:
configuring the endpoint to support one or more authentication tokens.

6. The method of claim 4, wherein the endpoint connects the first tenant to the data store of the authentication system that is associated with the first tenant.

7. The method of claim 1, wherein attributes of the first set of attributes associated with the first identity provider are application programming interface (API) schema attributes.

8. The method of claim 1, wherein:
the one or more request messages are user management request messages,
the data from the one or more request messages comprises user management data, and
the data store associated with the first tenant is associated with the user management data for one or more users associated with the first tenant.

9. The method of claim 1, wherein:
the authentication system comprises a plurality of data stores for the one or more tenants that includes the data store associated with the first tenant,
the first identity provider is included within a plurality of identity providers that are associated with different sets of one or more tenants, and
the first connection is included within a plurality of connections between respective identity providers and the authentication system.

10. A method for user management by an authentication system, comprising:
receiving, for a first connection between a first identity provider and an application associated with the authentication system, an indication of a mapping between a first set of attributes associated with the first identity provider and a second set of attributes associated with the authentication system, the first identity provider associated with a one or more tenants;
receiving, from a first tenant of the one or more tenants associated with the first identity provider, a request message comprising a set of data associated with the first set of attributes;
mapping, in response to receiving the request message, the set of data of the request message to the second set of attributes associated with the authentication system in accordance with the indication of the mapping for the first connection; and
storing the set of data from the request message in a data store associated with the authentication system based at least in part on mapping the set of data of the request message to the second set of attributes associated with the authentication system, the data store associated with the first tenant.

11. The method of claim 10, further comprising:
receiving, from the first tenant, a second request message indicating a request to read a second set of data from the data store at the authentication system that is associated with the first tenant, the second request message comprising an indication of the second set of data associated with the first set of attributes;
mapping, in response to receiving the second request message, the second set of data of the request message to the second set of attributes associated with the authentication system in accordance with the indication of the mapping for the first connection;
querying the data store associated with the first tenant for the second set of data that is associated with the second set of attributes to obtain the second set of data from the data store;
mapping, in response to obtaining the second set of data from the data store, the second set of data obtained from the data store to the first set of attributes associated with the first identity provider; and
transmitting, to the first tenant, a response message comprising the second set of data requested via the second request message, the second set of data associated with the first set of attributes, wherein the response message is transmitted based at least in part on obtaining the second set of data and mapping the second set of data to the first set of attributes.

12. The method of claim 10, wherein receiving the request message comprises:
receiving the request message via an endpoint at the authentication system for one or more request messages from the first tenant, the endpoint associated with the first tenant.

13. The method of claim 10, wherein receiving the request message comprises:
receiving, from the first tenant, an authentication token via the request message, wherein mapping the set of data of the request message to the second set of attributes associated with the authentication system is based at least in part on authenticating the authentication token from the first tenant.

14. The method of claim 10, wherein receiving the indication of the mapping comprises:
receiving, via the indication of the mapping, an indication of a mapping between a first set of user schema attributes of an application programming interface (API) message and a second set of user schema attributes of the data store associated with the authentication system, the first set of attributes comprising the first set of user schema attributes and the second set of attributes comprising the second set of attributes, wherein the request message is an API message.

15. The method of claim 14, wherein mapping the set of data of the request message to the second set of attributes comprises:
mapping a set of data associated with the first set of user schema attributes of the API message to the second set of user schema attributes of the authentication system.

16. The method of claim 10, wherein the request message indicates a request for the authentication system to execute one or more operations, the one or more operations comprising a data retrieval operation, a data storage operation, a data update operation, a data removal operation, or any combination thereof.

17. The method of claim 10, wherein the request message is associated with user management between the first tenant and the authentication system.

18. An authentication system for user management, comprising:
one or more memories storing processor-executable code; and
one or more processors coupled with the one or more memories and individually or collectively operable to execute the code to cause the authentication system to:
receive, for a first connection between a first identity provider and an application associated with the authentication system, an indication of a mapping between a first set of attributes associated with the first identity provider and a second set of attributes associated with the authentication system, the first identity provider associated with a one or more tenants;
receive, from a first tenant of the one or more tenants associated with the first identity provider, a request message comprising a set of data associated with the first set of attributes;
mapping, in response to receive the request message, the set of data of the request message to the second set of attributes associated with the authentication system in accordance with the indication of the mapping for the first connection; and
store the set of data from the request message in a data store associated with the authentication system based at least in part on mapping the set of data of the request message to the second set of attributes associated with the authentication system, the data store associated with the first tenant.

19. The authentication system of claim 18, wherein the one or more processors are individually or collectively further operable to execute the code to cause the authentication system to:
receive, from the first tenant, a second request message indicating a request to read a second set of data from the data store at the authentication system that is associated with the first tenant, the second request message comprising an indication of the second set of data associated with the first set of attributes;
map, in response to receive the second request message, the second set of data of the request message to the second set of attributes associated with the authentication system in accordance with the indication of the mapping for the first connection;
query the data store associated with the first tenant for the second set of data that is associated with the second set of attributes to obtain the second set of data from the data store;
map, in response to obtain the second set of data from the data store, the second set of data obtained from the data store to the first set of attributes associated with the first identity provider; and
transmit, to the first tenant, a response message comprising the second set of data requested via the second request message, the second set of data associated with the first set of attributes, wherein the response message is transmitted based at least in part on obtaining the second set of data and mapping the second set of data to the first set of attributes.

20. The authentication system of claim 18, wherein, to receive the indication of the mapping, the one or more processors are individually or collectively operable to execute the code to cause the authentication system to:
receive, via the indication of the mapping, an indication of a mapping between a first set of user schema attributes of an application programming interface (API) message and a second set of user schema attributes of the data store associated with the authentication system, the first set of attributes comprising the first set of user schema attributes and the second set of attributes comprising the second set of attributes, wherein the request message is an API message.
